(19) United States
(12) Patent Application Publication
(10) Pub. No.: US 2008/0092761 A1
(43) Pub. Date: Apr. 24, 2008

(54) Printing machine control method and printing machine

(75) Inventors: Satoru Kiyohara, Kyoto (JP); Kazuki Fukui, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/907,738

(22) Filed: Oct. 17, 2007

(30) Foreign Application Priority Data
Oct. 18, 2006 (JP) 2006-283643
Sep. 18, 2007 (JP) 2007-240636

(51) Int. Cl. B41F 1/40

(52) U.S. Cl. 101/335; 101/484

(57) ABSTRACT

A printing machine control method according to this invention includes a platemaking step for making a printing plate having, formed thereon, a test pattern with different dot percentages for areas corresponding to ink keys, a first printing step for making prints by using the printing plate; a first density measuring step for measuring and storing, at intervals of time, density of the test pattern on printing paper, a second printing step for making prints after changing opening of the ink keys, a second density measuring step for measuring and storing, at intervals of time, density of the test pattern on printing paper, and a control step for correcting an amount of change in the opening of the ink keys based on the density measured in the first density measuring step and the density measured in the second density measuring step, and correcting an interval between changes in the opening of the ink keys based on a time taken until stabilization of the density measured in the second density measuring step.

### BACKGROUND OF THE INVENTION

1. Field of the Invention

This invention relates to a printing machine control method and a printing machine.

2. Description of the Related Art

In a printing machine, an ink feed rate is adjusted by detecting densities of control strips or the like printed on printing paper, and changing opening amounts of ink keys based on results of the detection. In order to obtain data for adjusting the opening amounts of the ink keys, an optimal control parameter is determined by printing a chart for adjustment while, manually changing parameters for printing.

However, a parameter obtained in this way may not prove optimal, depending on the environment in which the printing machine is installed. The parameter may become unsuitable also when conditions such as the type of printing paper and the type of ink are changed.

Japanese Unexamined Patent Publication No. 2005-231221 discloses an ink feeding method in which an ink feed rate is corrected based on an expected color density and a target color density after a predetermined number of prints X are made. The predetermined number of prints is changed based on the target color density and the color density of an X-th print made after the correction. In this way, the predetermined number of prints X may be set easily as a parameter.

The ink feeding method described in the above publication is excellent in being capable of easily setting a parameter for controlling an ink feed rate. However, this ink feeding method cannot automatically set a parameter such as an amount of change in the opening of ink keys, or an interval between changes.

### SUMMARY OF THE INVENTION

The object of this invention, therefore, is to provide a printing machine control method and a printing machine capable of automatically obtaining information needed for controlling amounts of opening of ink keys, such as an amount of change in the opening of the ink keys and an interval between changes.

The above object is fulfilled, according to this invention, by a printing machine control method for controlling opening of ink keys by performing a self-diagnostic job in a printing machine which controls an ink feed rate by changing opening of ink keys based on results of measurement of density on printing paper, the self-diagnostic job comprising a platemaking step for making a printing plate having, formed thereon, a test pattern with different dot percentages for areas corresponding to the respective ink keys of the printing machine; a printing step for printing on the printing paper by using the printing plate made in the platemaking step after changing the opening of the ink keys of the printing machine; a density measuring step for measuring and storing, at intervals of time, density of the test pattern on the printing paper printed in the printing step; and a control step for controlling the opening of the ink keys based on density data obtained in the density measuring step.

With this printing machine control method, information needed for controlling the opening of the ink keys can be obtained automatically by carrying out the self-diagnostic job.

In a preferred embodiment, the control step is executed to correct an amount of change in the opening of the ink keys based on an amount of variation in the density accompanying the change in the opening of the ink keys.

In another preferred embodiment, the control step is executed to correct an interval between changes in the opening of the ink keys based on a time elapsed until the density stabilizes after the change in the opening of the ink keys.

In another aspect of the invention, a printing machine control method is provided for controlling opening of ink keys by performing a self-diagnostic job in a printing machine which controls an ink feed rate by changing opening of ink keys based on results of measurement of density on a printing paper, the self-diagnostic job comprising a platemaking step for making a printing plate having, formed thereon, a test pattern with different dot percentages for areas corresponding to the respective ink keys of the printing machine; a first printing step for printing on a first printing paper by using the printing plate made in the platemaking step; a first density measuring step for measuring and storing, at intervals of time, density of the test pattern on the first printing paper printed in the first printing step; a second printing step for printing on a second printing paper by using the printing plate made in the platemaking step after changing the opening of the ink keys of the printing machine; a second density measuring step for measuring and storing, at intervals of time, density of the test pattern on the second printing paper printed in the second printing step; and a control step for correcting an amount of change in the opening of the ink keys based on the density measured in the first density measuring step and the density measured in the second density measuring step, and correcting an interval between changes in the opening of the ink keys based on a time taken until stabilization of the density measured in the second density measuring step.

Other features and advantages of the invention will be apparent from the following detailed description of the embodiments of the invention.

### BRIEF DESCRIPTION OF THE DRAWINGS

For the purpose of illustrating the invention, there are shown in the drawings several forms which are presently preferred, it being understood, however, that the invention is not limited to the precise arrangement and instrumentalities shown.

FIG. 1 is a schematic view of a printing machine to which the invention is applied;

FIG. 2 is a schematic side view of an ink feeder;

FIG. 3 is a plan view of the ink feeder;

FIG. 4 is a schematic side view of a dampening water feeder;

FIG. 5 is a schematic side view showing an imaging unit along with a paper discharge mechanism such as a paper discharge cylinder;

FIG. 6 is a block diagram of a principal electrical structure of the printing machine;

FIG. 7 is a flow chart showing a sequence of a self-diagnostic job;

FIG. 8 is a flow chart showing the sequence of the self-diagnostic job;

FIG. 9 is a flow chart showing the sequence of the self-diagnostic job;

FIG. 10 is a graph showing density variations occurring with opening of ink keys;

FIG. 11 is an explanatory view showing an example of test pattern;

FIG. 12 is a graph showing a relationship between opening of the ink keys and ink density after printing; and

FIG. 13 is a graph showing a relationship between opening of the ink keys and ink density after printing.

### DESCRIPTION OF THE PREFERRED EMBODIMENTS

### Construction of Printing Machine

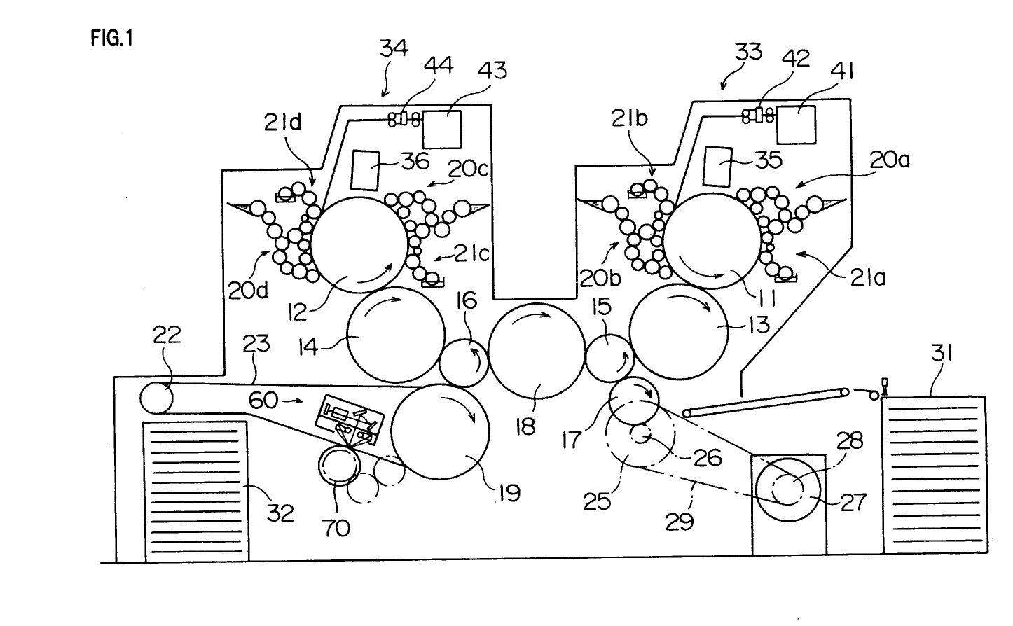

An embodiment of this invention will be described hereinafter with reference to the drawings. The construction of a printing machine to which the invention is applied will be described first. FIG. 1 is a schematic view of the printing machine to which the invention is applied.

This printing machine records images on blank plates mounted on first and second plate cylinders 11 and 12 in a prepress process, feeds inks to the plates having the images recorded thereon, and transfers the inks from the plates through first and second blanket cylinders 13 and 14 to printing paper held on first and second impression cylinders 15 and 16, thereby printing the images in four colors on the printing paper.

The printing machine has the first plate cylinder 11, the second plate cylinder 12, the first blanket cylinder 13 contactable with the first plate cylinder 11, the second blanket cylinder 14 contactable with the second plate cylinder 12, the first impression cylinder 15 contactable with the first blanket cylinder 13, and the second impression cylinder 16 contactable with the second blanket cylinder 14. The printing machine further includes a paper feed cylinder 17 for transferring printing paper supplied from a paper storage station 31 to the first impression cylinder 15, a transfer cylinder 18 for transferring the printing paper from the first impression cylinder 15 to the second impression cylinder 16, a paper discharge cylinder 19 with chains 23 wound thereon and extending to and wound on sprockets 22 for discharging printed paper from the second impression cylinder 16 to a paper discharge station 32, and an imaging unit 60 for reading the images printed on the printing paper.

Each of the first and second plate cylinders 11 and 12 is what is called a two-segmented cylinder for holding two printing plates peripherally thereof for printing in two different colors. The first and second blanket cylinders 13 and 14 have the same diameter as the first and second plate cylinders 11 and 12, and each has blanket surfaces for transferring images in two colors.

The first and second impression cylinders 15 and 16 movable into contact with the first and second blanket cylinders 13 and 14, respectively, have half the diameter of the first and second plate cylinders 11 and 12 and the first and second blanket cylinders 13 and 14. The first and second impression cylinders 15 and 16 have grippers, not shown, for holding and transporting the forward end of printing paper.

The paper feed cylinder 17 disposed adjacent the impression cylinder 15 has the same diameter as the first and second impression cylinders 15 and 16. The paper feed cylinder 17 has a gripper, not shown, for holding and transporting, with each intermittent rotation of the feed cylinder 17, the forward end of each sheet of printing paper fed from the paper storage station 31. When the printing paper is transferred from the feed cylinder 17 to the first impression cylinder 15, the gripper of the first impression cylinder 15 holds the forward end of the printing paper which has been held by the gripper of the feed cylinder 17.

The transfer cylinder 18 disposed between the first impression cylinder 15 and second impression cylinder 16 has the same diameter as the first and second plate cylinders 11 and 12 and the first and second blanket cylinders 13 and 14. The transfer cylinder 18 has a gripper, not shown, for holding and transporting the forward end of the printing paper received from the first impression cylinder 15, and transferring the forward end of the printing paper to the gripper of the second impression cylinder 16.

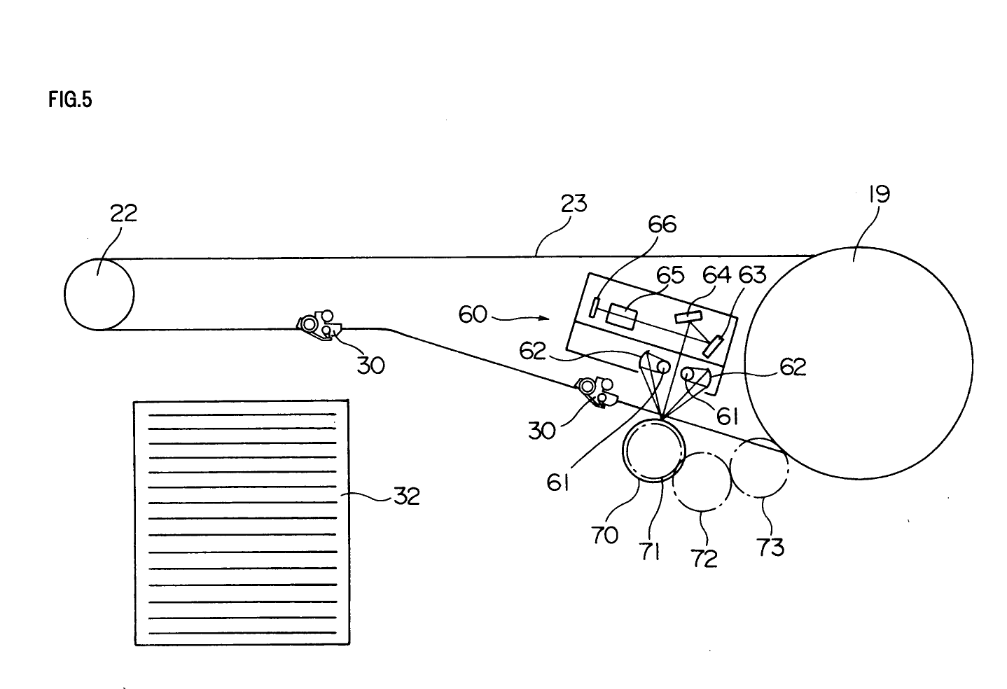

The paper discharge cylinder 19 disposed adjacent the second impression cylinder 16 has the same diameter as the first and second plate cylinders 11 and 12 and the first and second blanket cylinders 13 and 14. The discharge cylinder 19 has a pair of chains 23 wound around opposite ends thereof. The chains 23 are interconnected by coupling members, not shown, having a plurality of grippers 30 arranged thereon (FIG. 5). When the second impression cylinder 16 transfers the printing paper to the discharge cylinder 19, one of the grippers 30 on the discharge cylinder 17 holds the forward end of the printing paper having been held by the gripper of the second impression cylinder 16. With movement of the chains 23, the printing paper is transported to the paper discharge station 32 to be discharged thereon.

The paper feed cylinder 17 has a gear attached to an end thereof and connected to a gear 26 disposed coaxially with a driven pulley 25. A belt 29 is wound around and extends between the driven pulley 25 and a drive pulley 28 rotatable by a motor 27. Thus, the paper feed cylinder 17 is rotatable by drive of the motor 27. The first and second plate cylinders 11 and 12, first and second blanket cylinders 13 and 14, first and second impression cylinders 15 and 16, paper feed cylinder 17, transfer cylinder 18 and paper discharge cylinder 19 are coupled to one another by gears attached to ends thereof, respectively. Thus, by the drive of motor 27, the paper feed cylinder 17, first and second impression cylinders 15 and 16, paper discharge cylinder 19, first and second blanket cylinders 13 and 14, first and second plate cylinders 11 and 12 and transfer cylinder 18 are rotatable synchronously with one another.

The first plate cylinder 11 is surrounded by an ink feeder 20a for feeding an ink of black (K), for example, to a plate, an ink feeder 20b for feeding an ink of cyan (C), for example, to a plate, and dampening water feeders 21a and 21b for feeding dampening water to the plates. The second plate cylinder 12 is surrounded by an ink feeder 20c for feeding an ink of magenta (M), for example, to a plate, an ink feeder 20d for feeding an ink of yellow (Y), for example, to a plate, and dampening water feeders 21c and 21d for feeding dampening water to the plates.

Further, arranged around the first and second plate cylinders 11 and 12 are a plate feeder 33 for feeding plates to the peripheral surface of the first plate cylinder 11, a plate feeder 34 for feeding plates to the peripheral surface of the second plate cylinder 12, an image recorder 35 for recording images on the plates mounted peripherally of the first plate cylinder 11, and an image recorder 36 for recording images on the plates mounted peripherally of the second plate cylinder 12.

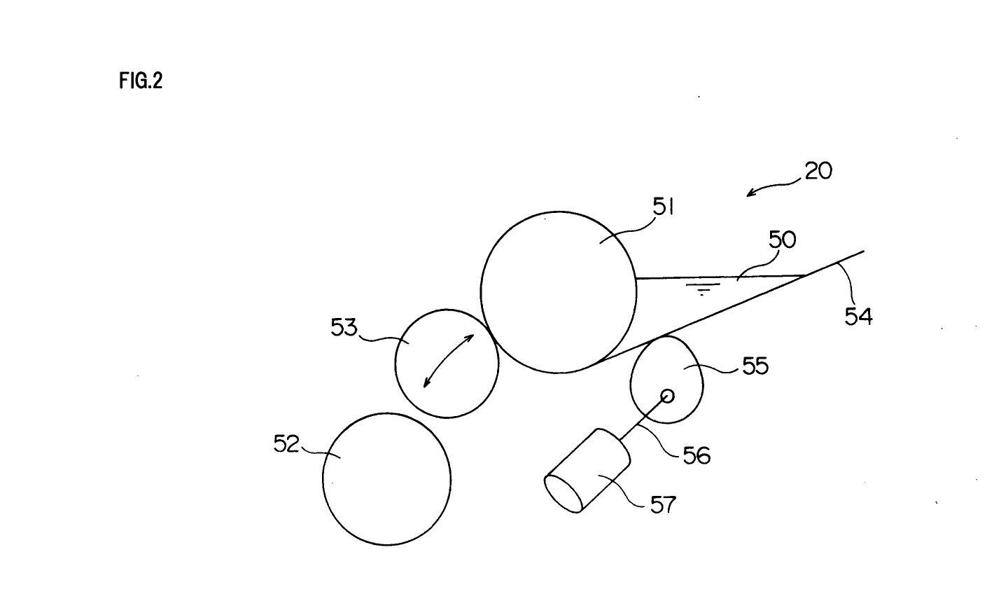

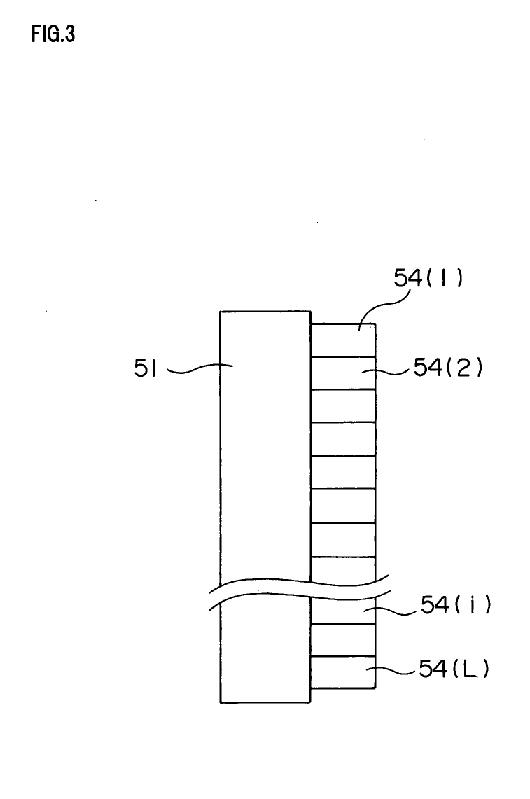

FIG. 2 is a schematic side view showing the ink feeder 20a among the above ink feeders 20a, 20b, 20c and 20d (which may be referred to collectively as “ink feeder 20”). FIG. 3 is a plan view thereof. Ink 50 is omitted from FIG. 3.

The ink feeder 20 includes an ink fountain roller 51 having an axis thereof extending in a direction of width of prints (i.e. perpendicular to a printing direction of the printing machine), and a plurality of ink rollers 52 (only one being shown in FIG. 2), and an ink transfer roller 53 that vibrates between the ink fountain roller 51 and a foremost one of the ink rollers 52. The ink feeder 20 further includes ink keys 54 (1), 54 (2) . . . 54 (L) (which may be referred to collectively as “ink keys 54”) arranged in the direction of width of the prints. The ink fountain roller 51 and ink keys 54 define an ink well for storing ink 50.

Eccentric cams 55, L in number, are arranged under the respective ink keys 54 for pressing the ink keys 54 toward the surface of ink fountain roller 51 to vary the opening degree of each ink key 54 with respect to the ink fountain roller 51. The eccentric cams 55 are connected through shafts 56 to pulse motors 57, L in number, for rotating the eccentric cams 55, respectively.

Each pulse motor 57, in response to an ink key drive pulse applied thereto, rotates the eccentric cam 55 about the shaft 56 to vary a pressure applied to the ink key 54. The opening degree of the ink key 54 with respect to the ink fountain roller 51 is thereby varied to vary the rate of ink fed to the printing plate.

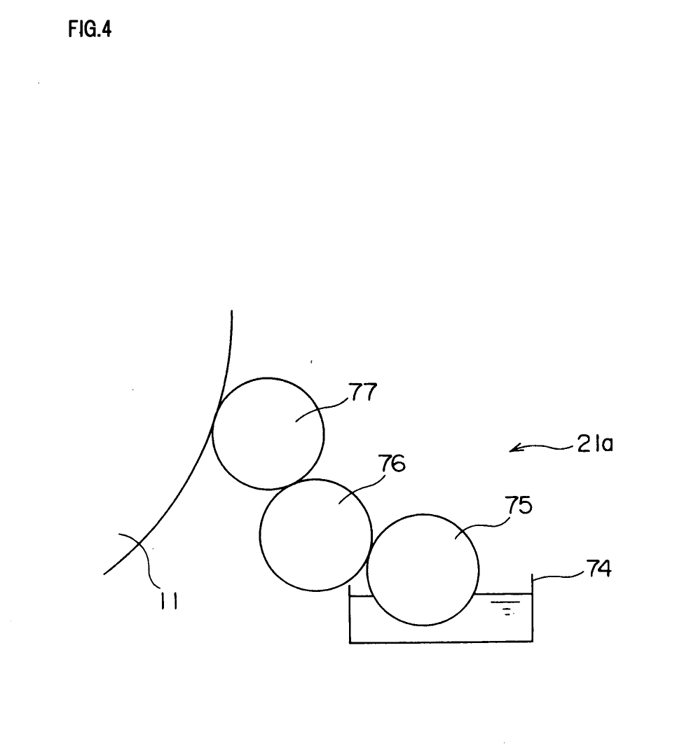

FIG. 4 is a schematic side view of the dampening water feeder 21a among the above dampening water feeders 21a, 21b, 21c and 21d (which may be referred to collectively as “dampening water feeder 21”).

The dampening water feeder 21a includes a water source having a water vessel 74 for storing dampening water and a water fountain roller 75 rotatable by a motor 78, to be described hereinafter, and two water rollers 76 and 77 for transferring the dampening water from the fountain roller 75 to the surface of one of the plates mounted peripherally of the first plate cylinder 11. This dampening water feeder is capable of adjusting the feed rate of dampening water to the surface of the plate by varying the rotating rate of fountain roller 75.

FIG. 5 is a schematic side view showing the imaging unit 60 along with the paper discharge mechanism such as the paper discharge cylinder 19.

The imaging unit 60 is used to read images printed on the printing paper and measure densities of printing control scales.

The pair of chains 23 are endlessly wound around the opposite ends of the paper discharge cylinder 19 and the pair of sprockets 22. As noted hereinbefore, the chains 23 are interconnected by coupling members, not shown, having a plurality of grippers 30 arranged thereon each for gripping the forward end of printing paper transported. FIG. 5 shows only two grippers 30, with the other grippers 30 omitted.

The pair of chains 23 have a length corresponding to a multiple of the circumference of first and second impression cylinders 15 and 16. The grippers 30 are arranged on the chains 23 at intervals each corresponding to the circumference of first and second impression cylinders 15 and 16. Each gripper 30 is opened and closed by a cam mechanism, not shown, synchronously with the gripper on the paper discharge cylinder 19. Thus, each gripper 30 receives the printing paper from the paper discharge cylinder 19, transports the printing paper with rotation of the chains 23, and is then opened by the cam mechanism, not shown, to discharge the paper on the paper discharge station 32.

The printing paper is transported with only the forward end thereof held by one of the grippers 30, the rear end of printing paper not being fixed. Consequently, the printing paper could flap during transport, which impairs an operation, to be described hereinafter, of the imaging unit 60 to read images and measure densities of printing control scales S. To avoid such an inconvenience, this printing machine provides a suction roller 70 disposed upstream of the paper discharge station 32 for stabilizing the printing paper transported.

The suction roller 70 is in the form of a hollow roller having a surface defining minute suction bores, with the hollow interior thereof connected to a vacuum pump not shown. The suction roller 70 has a gear 71 attached to an end thereof. The gear 71 is connected through idler gears 72 and 73 to the gear attached to an end of the paper discharge cylinder 19. Consequently, the suction roller 43 is driven to rotate in a matching relationship with a moving speed of the grippers 30. Thus, the printing paper is sucked to the surface of the suction roller 70, thereby being held against flapping when passing over the suction roller 70. In place of the suction roller 70, a suction plate may be used to suck the printing paper two-dimensionally.

The above imaging unit 60 includes a pair of linear light sources 61 extending parallel to the suction roller 70 for illuminating the printing paper on the suction roller 70, a pair of condensing plates 62, reflecting mirrors 63 and 64, a condensing lens 65 and a CCD line sensor 66. The printing paper transported by the paper discharge mechanism including the paper discharge cylinder 19 and chains 23 are illuminated by the pair of linear light sources 61, and photographed by the CCD line sensor 66.

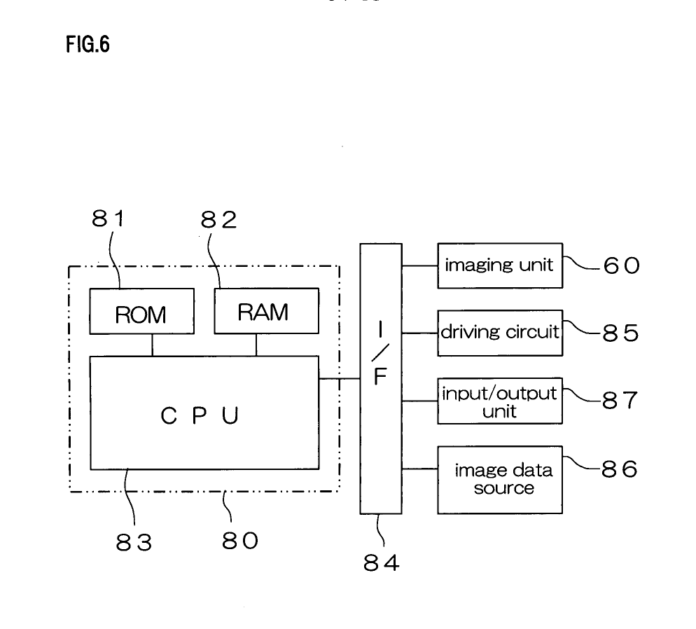

FIG. 6 is a block diagram showing a principal electrical structure of the printing machine.

This printing machine includes a control unit 80 having a ROM 81 for storing operating programs necessary for controlling the machine, a RAM 82 for temporarily storing data and the like during a control operation, and a CPU 83 for performing logic operations. The control unit 80 is connected to the above imaging unit 60 through an interface 84. Further, the control unit 80 is connected through the interface 84 to a driving circuit 85 for generating driving signals for driving the ink feeders 20, dampening water feeders 21, image recorders 35 and 36 and so on. The control unit 80 is connected also to an input/output unit 87 having a control panel of the touch panel type using liquid crystal to be capable of inputting data and displaying images. The control unit 80 is connected, through the interface 84, also to an image data source 86 storing the data of images for use in platemaking and printing.

The printing machine is controlled by this control unit 80 to execute a printing operation including a self-diagnostic job as described hereinafter. The RAM 82 of the control unit 80 acts as a storage device for storing density measurements provided by the imaging unit 60.

In the printing machine having the above construction, a printing plate stock drawn from a supply cassette 41 of the plate feeder 33 is cut to a predetermined size by a cutter 42. The forward end of each plate in cut sheet form is guided by guide rollers and guide members, not shown, and is clamped by clamps of the first plate cylinder 11. Then, the first plate cylinder 11 is driven by a motor, not shown, to rotate at low speed, whereby the plate is wrapped around the peripheral surface of the first plate cylinder 11. The rear end of the plate is clamped by other clamps of the first plate cylinder 11. While, in this state, the first plate cylinder 11 is rotated at high speed, the image recorder 35 irradiates the surface of the plate mounted peripherally of the first plate cylinder 11 with a modulated laser beam for recording an image thereon.

Similarly, a printing plate stock drawn from a supply cassette 43 of the plate feeder 34 is cut to the predetermined size by a cutter 44. The forward end of each plate in cut sheet form is guided by guide rollers and guide members, not shown, and is clamped by clamps of the second plate cylinder 12. Then, the second plate cylinder 12 is driven by a motor, not shown, to rotate at low speed, whereby the plate is wrapped around the peripheral surface of the second plate cylinder 12. The rear end of the plate is clamped by other clamps of the second plate cylinder 12. While, in this state, the second plate cylinder 12 is rotated at high speed, the image recorder 36 irradiates the surface of the plate mounted peripherally of the second plate cylinder 12 with a modulated laser beam for recording an image thereon.

The first plate cylinder 11 has, mounted peripherally thereof, a plate for printing in black ink and a plate for printing in cyan ink. The two plates are arranged in evenly separated positions (i.e. in positions separated from each other by 180 degrees). The image recorder 35 records images on these plates. Similarly, the second plate cylinder 12 has, mounted peripherally thereof, a plate for printing in magenta ink and a plate for printing in yellow ink. The two plates also are arranged in evenly separated positions, and the image recorder 36 records images on these plates, to complete a prepress process.

The prepress process is followed by a printing process for printing the printing paper with the plates mounted on the first and second plate cylinders 11 and 12. This printing process is carried out as follows.

First, each dampening water feeder 21 and each ink feeder 20 are placed in contact with only a corresponding one of the plates mounted on the first and second plate cylinders 11 and 12. Consequently, dampening water and inks are fed to the plates from the corresponding water feeders 21 and ink feeders 20, respectively. These inks are transferred from the plates to the corresponding regions of the first and second blanket cylinders 13 and 14, respectively.

Then, the printing paper is fed to the paper feed cylinder 17. The printing paper is subsequently passed from the paper feed cylinder 17 to the first impression cylinder 15. The impression cylinder 15 having received the printing paper continues to rotate. Since the first impression cylinder 15 has half the diameter of the first plate cylinder 11 and the first blanket cylinder 13, the black ink is transferred to the printing paper wrapped around the first impression cylinder 15 in its first rotation, and the cyan ink in its second rotation.

After the first impression cylinder 15 makes two rotations, the printing paper is passed from the first impression cylinder 15 to the second impression cylinder 16 through the transfer cylinder 18. The second impression cylinder 16 having received the printing paper continues to rotate. Since the second impression cylinder 16 has half the diameter of the second plate cylinder 12 and the second blanket cylinder 14, the magenta ink is transferred to the printing paper wrapped around the second impression cylinder 16 in its first rotation, and the yellow ink in its second rotation.

The forward end of the printing paper printed in the four colors in this way is passed from the second impression cylinder 16 to the paper discharge cylinder 19. The printing paper is transported by the pair of chains 23 toward the paper discharge station 32 to be discharged thereon. At this time, the detecting patches on the printing paper being transported are illuminated by the pair of linear light sources 61, and are photographed by the CCD line sensor 66 of the imaging unit 60.

In the printing process, the image printed on the printing paper is measured by the CCD line sensor 66 of the imaging unit 60. The ink feed rates are controlled based on color values at a representative point on the image to adjust a color tone.

After the printing process, the printing paper printed is discharged. The first and second blanket cylinders 13 and 14 are cleaned by a blanket cylinder cleaning device, not shown, to complete the printing process.

[Execution of Self-Diagnostic Job]

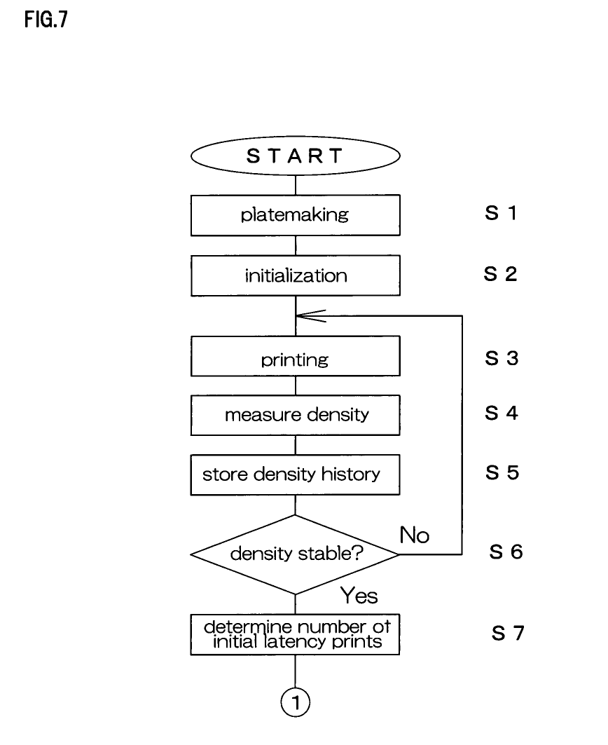

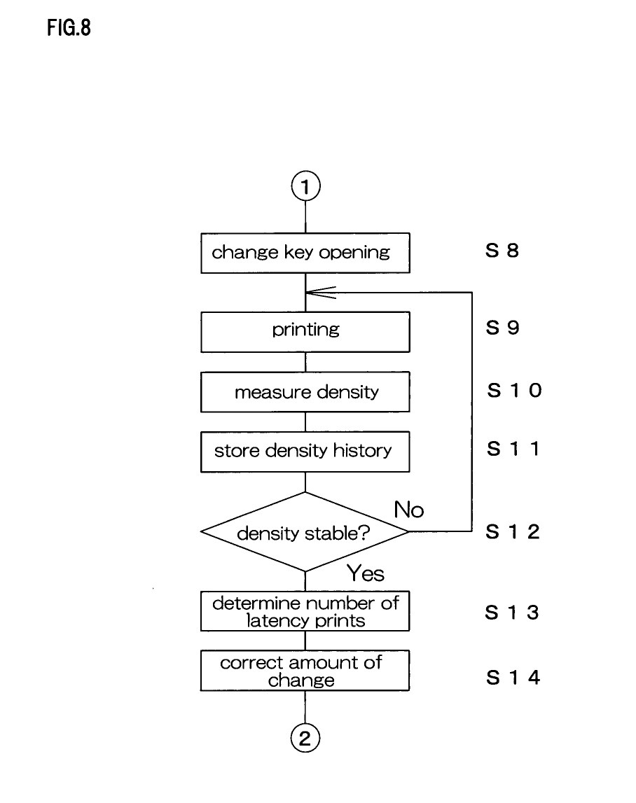

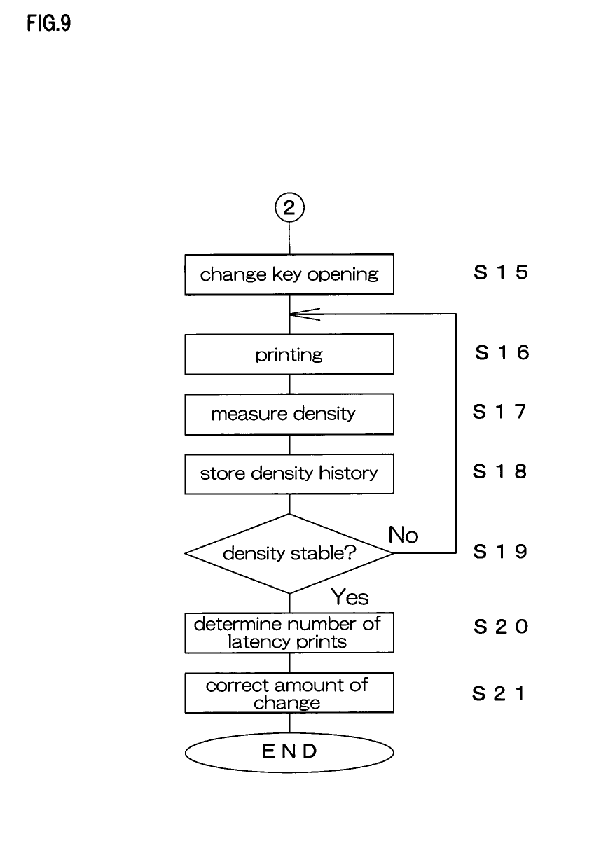

Next, the self-diagnostic job which is the characterizing feature of this invention will be described. FIGS. 7 through 9 are flow charts showing the sequence of the self-diagnostic job according to this invention.

This self-diagnostic job is stored in the RAM 82 of the controller 80 shown in FIG. 6. The self-diagnostic job is performed in response to a run command given by the operator through the input/output unit 87.

When the self-diagnostic job is performed on the instruction given by the operator, a printing plate with a test pattern for self-diagnosis formed thereon is prepared first (step S1). This test pattern has different dot percentages for areas corresponding to the respective ink keys 54 of the printing machine.

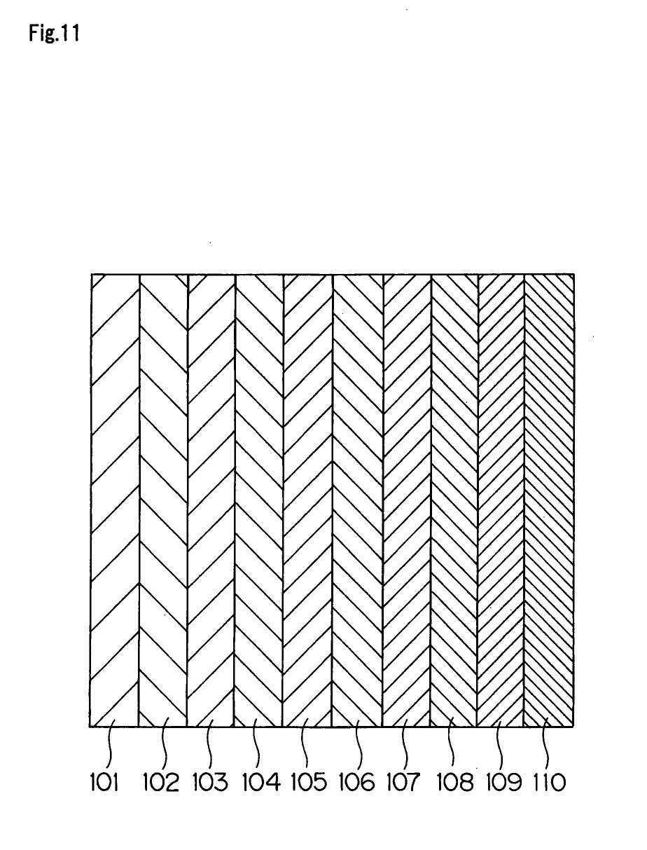

FIG. 11 is an explanatory view showing an example of such test pattern. In this figure, the vertical direction corresponds to a printing direction.

Where, for example, the number L of ink keys 54 shown in FIG. 3 is ten, the plate made has a pattern with uniform hatches having various dot percentages as shown in FIG. 11. Specifically, the dot percentages are 5% for an area 101 of the plate corresponding to the first key, 10% for an area 102 corresponding to the second key, 15% for an area 103 corresponding to the third key, 20% for an area 104 corresponding to the fourth key, 30% for an area 105 corresponding to the fifth key, 50% for an area 106 corresponding to the sixth key, 70% for an area 107 corresponding to the seventh key, 80% for an area 108 corresponding to the eighth key, 90% for an area 109 corresponding to the ninth key, and 100% for an area 110 corresponding to the tenth key. Image data of this test pattern is supplied from the image data source 86 shown in FIG. 6.

Next, initialization for printing is carried out (step S2). At the time of initialization, the amounts of opening of the ink keys 54 are set to those corresponding to the above dot percentages.

In this state, printing is started (step S3). Then, the imaging unit 60 measures density of the areas corresponding to the ink keys on the test pattern printed on printing paper (step S4). A history of density is stored in the RAM 82 of the controller 80 shown in FIG. 6 (step S5).

The printing is continued in this state until density variations stabilize (step S6). Density variations are determined to have stabilized when, for example, variations in density value on the test pattern printed on 50 sheets have become less than 0.1 plus or minus.

When the density variations have stabilized, the number of prints consumed up to that time is determined as the “number of initial latency prints” which is the number of prints required until stabilization of printing density (step S7). For performing a next printing operation, it is determined that a latency period is necessary since density is unstable while the “number of initial latency prints” is made.

Next, all the ink keys 54 are opened to a greater degree from this state, each by an amount corresponding to 10% (step S8). However, the opening amount of the tenth key remains unchanged. In this state, printing is continued (step S9). Again, the imaging unit 60 measures densities of the areas corresponding to the ink keys on the test pattern printed on printing paper (step S10). A history of density is stored in the RAM 82 of the controller 80 shown in FIG. 6 (step S11).

The printing is continued in this state until density variations stabilize (step S12). In this case also, density variations are determined to have stabilized when, for example, variations in density value on the test pattern printed on last 50 sheets have become less than 0.1 plus or minus. When the density variations have stabilized, the number of prints consumed up to that time after the change is made in the opening of the ink keys 54 is determined as the “number of latency prints” which is the number of prints required until stabilization of the ink key opening when the ink keys are opened to larger extents (step S13).

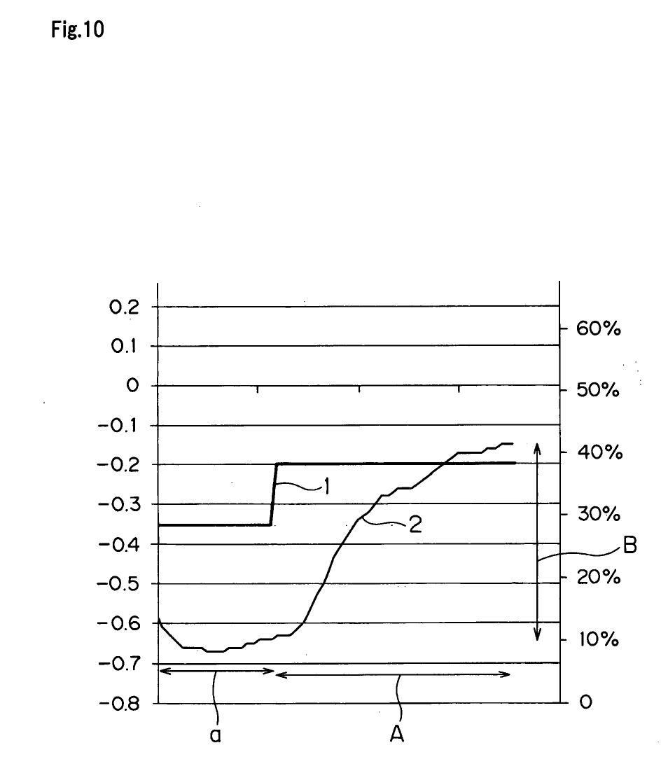

FIG. 10 is a graph showing density variations occurring with the further opening of the ink keys 54. In this graph, the vertical axis indicates density while the horizontal axis shows the number of prints.

In this figure, sign A indicates the number of latency prints. As noted above, the number of latency prints A is the number of prints required until ink density stabilizes after the ink keys 54 are further opened. Sign “a” indicates the number of initial latency prints noted hereinbefore. Thick line 1 indicates the opening of ink keys 54. Thin line 2 indicates density values of printing papers.

When the ink keys are opened at the time of a next printing operation, the density value of a printing paper is regarded as stable only after the “number of latency prints” is through. Whenever the “number of latency prints” is through, a control operation is carried out to change the opening of ink keys 54 based on density measurements provided by the imaging unit 60. That is, the “number of latency prints” is used in correcting an interval between changes in the ink key opening. The “number of latency prints” is determined for each dot percentage. Therefore, the “number of latency prints” is different from one dot percentage to another.

On the other hand, when density variations fail to stabilize even if a certain number of prints are made after changing the opening of ink keys 54, it is determined that a mechanical abnormality has occurred with the printing machine, and an abnormality indication is given. In other words, an abnormality of the printing machine is detected from the density data provided by the imaging unit 60.

Next, the amount of change in the opening of ink keys 54 is corrected with reference to the amount of density variation accompanying the change in the opening of ink keys 54 (step S14). That is, based on an amount of density variation B after stabilization of the density variations shown in FIG. 10, the amount of change in the opening of ink keys 54 is corrected by adjusting the strength of control.

For example, an amount of correction H is derived from the following equation:

H=(B−D)·C

where B is the amount of variation in density value in FIG. 10, D is a presumed amount of variation which is an amount of variation expected to result from an ink key being opened by a certain degree, and C is a coefficient.

A corrected strength of control T1 is derived from the following equation:

T1=1+(T0−1)×(1+H)

where T0 is the strength of control before the correction.

In the case shown in FIG. 10, for example, assuming that the variation B in density value is 0.5, the presumed amount of variation D is 0.2, coefficient C is 0.1, and the strength of control before the correction T0 is 1.2, the corrected strength of control T1 is obtained as follows:

T=1+(1.2−1)×(1+0.2×0.1)=1.204.

It means in this case that the strength of control is increased from 1.2 to 1.204. The strength of control is increased to enhance the convergence of control. On the other hand, when the variation B in density value is 0.1, the same equation will result in a decrease in the strength of control from 1.2 to 1.198. In this case, the strength of control is weakened. More particularly, for example, the strength of control is used for correcting the amount of change in the opening of ink keys 54, which is effected by multiplying the number of pulses applied to the pulse motor 57 for opening and closing each ink key 54, by the strength of control.

The above operation completes a correction of the amount of change in the opening of ink keys 54 at the time of increasing the opening of ink keys 54. Next, an operation is performed through a similar process for correcting the amount of change in the case of decreasing the opening of ink keys 54.

That is, all the ink keys 54 are closed, each by an amount corresponding to a dot percentage at 20% (which corresponds to a closing by 10% from the initial state) (step S15). Then, the printing operation is continued (step S16). The imaging unit 60 measures density of the areas corresponding to the ink keys on the test pattern printed on printing paper (step S17). A history of density is stored in the RAM 82 of the controller 80 shown in FIG. 6 (step S18).

Printing is continued in this state until density variations stabilize (step S19). When the density variations have stabilized, the number of prints consumed up to that time after the change is made in the opening of the ink keys 54 is determined as the “number of latency prints” which is the number of prints required until stabilization of the ink key opening when the ink keys are closed (step S20). Then, by using an equation to the equation described hereinbefore, the amount of change in the opening of ink keys 54 is corrected with reference to the variation in density value accompanying the change in the opening of ink keys 54 (step S21).

The above operation completes the self-diagnostic job. Then, printing plates are prepared for printing ordinary, desired images, and prints are made by performing usual control of an ink feed rate. At this time, the ink feed rate is controlled by using the amount of change and the interval between changes obtained from the above process.

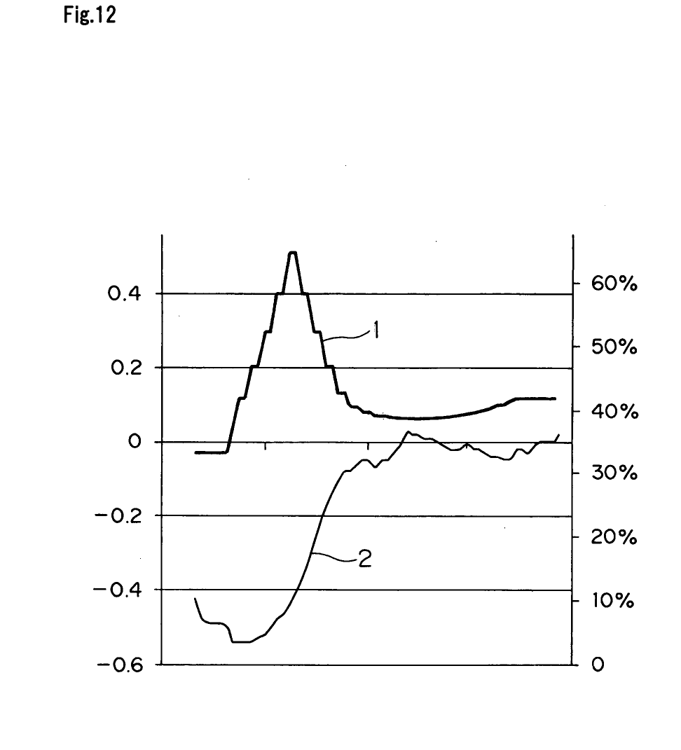

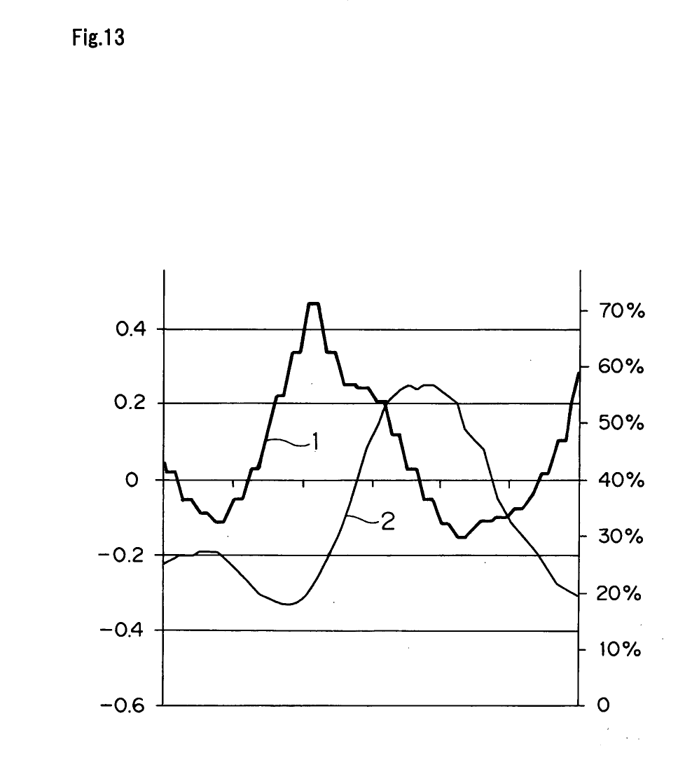

FIG. 12 is a graph showing a relationship between the opening of ink keys 54 and density value of printing papers, when the above self-diagnostic job has been carried out. FIG. 13 is a graph showing a relationship between the opening of ink keys 54 and density value of printing papers, when the self-diagnostic job has not been carried out. In these figures, thick line 1 indicates the opening of ink keys 54 while thin line 2 indicates density value of printing papers.

When the self-diagnostic job according to this invention has been carried out, as shown in FIG. 12, the relationship between the opening of ink keys 54 and density values of printing papers converges in a short time. On the other hand, when the self-diagnostic job according to this invention has not been carried out, as shown in FIG. 13, the opening and closing of ink keys 54 are ill-timed, resulting in a repetition of ink density increase and decrease.

Generally, the larger image area percentage of a printed image results in the faster stabilization of ink density, and conversely, the smaller image area percentage of a printed image results in the slower stabilization of ink density. However, the self-diagnostic job according to this invention carried out using a test pattern as shown in FIG. 11 can optimize the number of latency prints and the strength of control for each image area percentage.

In the foregoing embodiment, this invention has been described as applied to a printing machine having a platemaking function. This invention is applicable also to a platemaking apparatus and a printing machine independent of each other.

This invention may be embodied in other specific forms without departing from the spirit or essential attributes thereof and, accordingly, reference should be made to the appended claims, rather than to the foregoing specification, as indicating the scope of the invention.

This application claims priority benefit under 35 U.S.C. Section 119 of Japanese Patent Applications No. 2006-283643 filed in the Japanese Patent Office on Oct. 18, 2006 and No. 2007-240636 filed in the Japanese Patent Office on Sep. 18, 2007, the entire disclosure of which is incorporated herein by reference.

What is claimed is:

1. A printing machine control method for controlling opening of ink keys by performing a self-diagnostic job in a printing machine which controls an ink feed rate by changing the opening of the ink keys based on results of measurement of density on printing paper, said self-diagnostic job comprising:
a platemaking step for making a printing plate having, formed thereon, a test pattern with different dot percentages for areas corresponding to the respective ink keys of the printing machine;
a printing step for printing on the printing paper by using the printing plate made in said platemaking step, after changing the opening of the ink keys of the printing machine;
a density measuring step for measuring and storing, at intervals of time, density of the test pattern on the printing paper printed in said printing step; and
a control step for controlling the opening of said ink keys based on density data obtained in said density measuring step.

2. A printing machine control method as defined in claim 1, wherein said control step is executed to correct an amount of change in the opening of said ink keys based on an amount of variation in the density accompanying the change in the opening of the ink keys.

3. A printing machine control method as defined in claim 1, wherein said control step is executed to correct an interval between changes in the opening of said ink keys based on a time elapsed until the density stabilizes after the change in the opening of the ink keys.

4. A printing machine control method as defined in claim 1, wherein an abnormality of the printing machine is detected from the density data obtained in said density measuring step.

5. A printing machine control method for controlling opening of ink keys by performing a self-diagnostic job in a printing machine which controls an ink feed rate by changing the opening of the ink keys based on results of measurement of density on a printing paper, said self-diagnostic job comprising:
a platemaking step for making a printing plate having, formed thereon, a test pattern with different dot percentages for areas corresponding to the respective ink keys of the printing machine;
a first printing step for printing on a first printing paper by using the printing plate made in said platemaking step;
a first density measuring step for measuring and storing, at intervals of time, density of the test pattern on the first printing paper printed in said first printing step;
a second printing step for printing on a second printing paper by using the printing plate made in said platemaking step after changing the opening of the ink keys of the printing machine;
a second density measuring step for measuring and storing, at intervals of time, density of the test pattern on the second printing paper printed in said second printing step; and
a control step for correcting an amount of change in the opening of said ink keys based on the density measured in said first density measuring step and the density measured in said second density measuring step, and correcting an interval between changes in the opening of said ink keys based on a time taken until stabilization of the density measured in said second density measuring step.

6. A printing machine for controlling an ink feed rate by changing opening of ink keys based on results of measurement of density on a printing paper, and controlling the opening of the ink keys by performing a self-diagnostic job, said printing machine comprising:
an imaging unit for measuring density of a test pattern printed on the printing paper, and a storage device for storing density measurements provided by said imaging unit;
said self-diagnostic job comprising:
printing on the printing paper by using a printing plate having, formed thereon, a test pattern with different dot percentages for areas corresponding to the respective ink keys of the printing machine, after changing the opening of the ink keys of the printing machine; and
measuring density of the test pattern printed on the printing paper, at intervals of time, through said imaging unit, storing density data in said storage device, and controlling the opening of said ink keys based on said density data.

7. A printing machine as defined in claim 6, wherein an amount of change in the opening of said ink keys is corrected based on an amount of variation in the density accompanying the change in the opening of the ink keys.

8. A printing machine as defined in claim 6, wherein an interval between changes in the opening of said ink keys is corrected based on a time elapsed until the density stabilizes after the change in the opening of the ink keys.

9. A printing machine as defined in claim 6, further comprising a platemaking mechanism for making the printing plate having, formed thereon, the test pattern with different dot percentages for the areas corresponding to the respective ink keys of the printing machine.

10. A printing machine for controlling an ink feed rate by changing opening of ink keys based on results of measurement of density on a printing paper, and controlling the opening of the ink keys by performing a self-diagnostic job, said printing machine comprising:
an imaging unit for measuring density of a test pattern printed on the printing paper, and a storage device for storing density measurements provided by said imaging unit;
said self-diagnostic job comprising:
performing a first printing for printing on a first printing paper by using a printing plate having, formed thereon, a test pattern with different dot percentages for areas corresponding to the respective ink keys of the printing machine, and measuring and storing in said storage device, at intervals of time, density of the test pattern printed on the first printing paper;
performing a second printing for printing on a second printing paper by using said printing plate after changing the opening of the ink keys of the printing machine, and measuring and storing, at intervals of time, density of the test pattern printed on the second printing paper; and
correcting an amount of change in the opening of said ink keys based on the density in time of the first printing and the density in time of the second printing stored in said storage device, and correcting an interval between changes in the opening of said ink keys based on a time taken until stabilization of the density in time of the second printing.
